(19) United States
(12) Patent Application Publication
(10) Pub. No.: US 2017/0039902 A1
(43) Pub. Date: Feb. 9, 2017

(54) DOUBLE SIDE DISPLAY DEVICE, DRIVING METHOD AND ELECTRONIC DEVICE

(71) Applicants: BOE TECHNOLOGY GROUP CO., LTD., Beijing (CN); BEIJING BOE DISPLAY TECHNOLOGY CO., LTD., Beijing (CN)

(72) Inventors: Weichao MA, Beijing (CN); Zhihua SUN, Beijing (CN); Baoyu LIU, Beijing (CN)

(73) Assignees: BOE TECHNOLOGY GROUP CO., LTD., Beijing (CN); BEIJING BOE DISPLAY TECHNOLOGY CO., LTD., Beijing (CN)

(21) Appl. No.: 14/912,338

(22) PCT Filed: Jul. 20, 2015
(86) PCT No.: PCT/CN2015/084444

§ 371 Date: Feb. 16, 2016

(30) Foreign Application Priority Data
Mar. 11, 2015 (CN) 201510105644.1

(51) Int. Cl. G09F 9/305; G09G 3/34; G09F 13/04

(52) U.S. Cl. CPC G09F 9/305; G09F 13/0413; G09G 3/3406; G09G 2320/0233

(57) ABSTRACT

The present disclosure provides a double side display device, a method for driving the double side display device and an electronic device. The double side display device includes: a first display panel; a second display panel; a backlight source which includes a case and bare optical fibers arranged in the case; a light source; and external optical fibers. A leakage prevention layer is arranged surrounding each of the external optical fibers and configured to prevent light from leaking. An output end of the light source is connected to a first end of each of the bare optical fibers via one of the external optical fibers. And the case is arranged between the first display panel and the second display panel.

### CROSS REFERENCE OF RELATED APPLICATION

The present application claims a priority of Chinese Patent Application No. 201510105644.1 filed on Mar. 11, 2015, the disclosure of which is incorporated herein by reference in its entirety.

### TECHNICAL FIELD

The present disclosure relates to the technical field of displaying, in particular to a double side display device, a method for driving the double side display device, and an electronic device.

### BACKGROUND

A conventional double side display device has disadvantages of high power consumption and large thickness. In general, a light-emitting element of a backlight of the conventional double side display device is a cold cathode fluorescent lamp (CCFL), a single side light-emitting diode (LED), a double side LED or etc. The CCFL is of a large size and high power consumption, and now generally adopted in an outdoor billboard. The single side LED requires a particular light guide plate (LGP), and thus is of high cost and low luminance. The double side LED is of high cost, high power consumption, and generates a considerable amount of heat. The conventional double side display device including the above light-emitting element has disadvantages of high power consumption, large thickness and high cost.

### SUMMARY

An object of the present disclosure is to provide a double side display device, a method for driving the double side display device and an electronic device, so as to reduce the power consumption, the thickness and the cost of the conventional double side display device.

In one aspect, the present disclosure provides in sonic embodiments a display device, including: a first display panel; a second display panel; a backlight source which includes a case and bare optical fibers arranged in the case; a light source; and external optical fibers,

wherein a leakage prevention layer is arranged surrounding each of the external optical fibers and configured to prevent light from leaking;

an output end of the light source is connected to a first end of each of the bare optical fibers via one of the external optical fibers, and

the case is arranged between the first display panel and the second display panel.

Alternatively, second ends of the bare optical fibers are connected to an input end of the light source via the external optical fibers.

Alternative, the double side display device further includes an electronically-controlled optical fiber coupler,

wherein there is a plurality of bare optical fibers, each of which corresponds to one or more rows of pixel units on the display panels;

the light source is connected to an input end of the electronically-controlled optical fiber coupler via the external optical fibers, and output ends of the electronically-controlled optical fiber coupler are connected to the first ends of the bare optical fibers in a one-to-one correspondence manner via the external optical fibers; and

second ends of the bare optical fibers are connected to an input end of the light source via the external optical fibers.

Alternatively, the double side display device further includes: a first timing controller, a second timing controller, a micro controller unit and a direct current (DC) power conversion chip, wherein

the first timing controller is configured to obtain a display data signal of each row of the pixel units on the first display panel from each data line in turn, and parse the obtained display data signal;

the second timing controller is configured to obtain a display data signal of each row of the pixel units on the second display panel from each data line in turn, and parse the obtained display data signal;

the micro controller unit is configured to obtain intensity control signals based on parsing results from the first timing controller and the second timing controller and corresponding to the display data signals of each row of the pixel units on the first display panel and the second display panel;

the DC power conversion chip is configured to obtain intensity adjusting voltages based on the intensity control signals; and

the electronically-controlled optical fiber coupler is further configured to adjust intensities of light beams outputted by the output ends based on the intensity adjusting voltages.

Alternatively, the double side display device further includes a circuit board, wherein

the electronically-controlled optical fiber coupler, the first timing controller, the second timing controller, the micro controller unit and the DC power conversion chip are mounted on the circuit board.

Alternatively, the light source is integrated on the circuit board.

Alternatively, the double side display device further includes: a plurality of transparent protection tubes, wherein each of the bare optical fibers is arranged within a corresponding transparent protection tube.

Alternatively, the light source is a pump light source, and the leakage prevention layer is a reflective film.

In another aspect, the present disclosure provides in some embodiments a method for driving the double side display device, including:

obtaining, by the first timing controller, a display data signal of each row of the pixel units on the first display panel from each data line in turn, and parsing the obtained display data signal;

obtaining, by the second timing controller, a display data signal of each row of the pixel units on the second display panel from each data line in turn, and parsing the obtained display data signal;

obtaining, by the micro controller unit, intensity control signals based on parsing results from the first timing controller and the second timing controller and corresponding to the display data signals of each row of the pixel units on the first display panel and the second display panel;

obtaining, by the DC power conversion chip, intensity adjusting voltages based on the intensity control signals; and

adjusting, by the electronically-controlled optical fiber coupler, intensities of light beams outputted to the first ends of the bare optical fibers based on the intensity adjusting voltages.

In another aspect, the present disclosure provides in some embodiments an electrical device including the above double side display device.

Compared with the prior art, in the double side display device, the method for driving the double side display device and the electronic device of the present disclosure, the light emitted by the light source enters the case arranged between the two display panel via the optical fiber. In such arrangement, the thickness, the power consumption and the cost of the double side display device may be reduced because the optical fiber has advantages of small size, low cost and less heat being generated.

### BRIEF DESCRIPTION OF THE DRAWINGS

FIG. 1 is a general schematic view showing a double side display device according to an embodiment of the present disclosure;

FIG. 2 is a schematic view of a light source, external optical fibers and a backlight source included in the double side display device according to an embodiment of the present disclosure; and

FIG. 3 is a schematic view showing the double side display device with more details according to an embodiment of the present disclosure.

### DETAILED DESCRIPTION

In the following, it is clearly and completely described the technical solutions according to the embodiments of the present disclosure. It is obvious that the described embodiments are merely some of all the embodiment of the present disclosure instead of all the embodiments. All of other embodiment that those skilled in the art may implement based on the embodiments in the present disclosure without creative work should also fall within the scope of the present disclosure.

Unless otherwise defined, any technical or scientific term used herein shall have the common meaning understood by a person of ordinary skills. Such words as “first” and “second” used in the specification and claims are merely used to differentiate different components rather than to represent any order, number or importance. Similarly, such words as “one” or “a” are merely used to represent the existence of at least one member, rather than to limit the number thereof. Such words as “connect” or “connected to” may include electrical connection, direct or indirect, rather than to be limited to physical or mechanical connection. Such words as “on”, “under”, “left” and “right” are merely used to represent relative position relationship, and when an absolute position of the object is changed, the relative position relationship will be changed too.

In an embodiment of the present disclosure, the double side display device includes a first display panel, a second display panel and a backlight module. The backlight source includes a case and bare optical fibers arranged in the case. The double side display device further includes a light source and external optical fibers. A leakage prevention layer is arranged surrounding each of the external optical fibers and configured to prevent light from leaking. An output end of the light source is connected to a first end of each of the bare optical fibers via one of the external optical fibers. The case is arranged between the first display panel and the second display panel.

In the double side display device of the present disclosure, the light emitted by the light source enters into the case between the two display panels via the optical fibers. In such arrangement, the thickness, the power consumption and the cost of the double side display device may be reduced because the optical fiber has advantages of small size, low cost and less heat being generated.

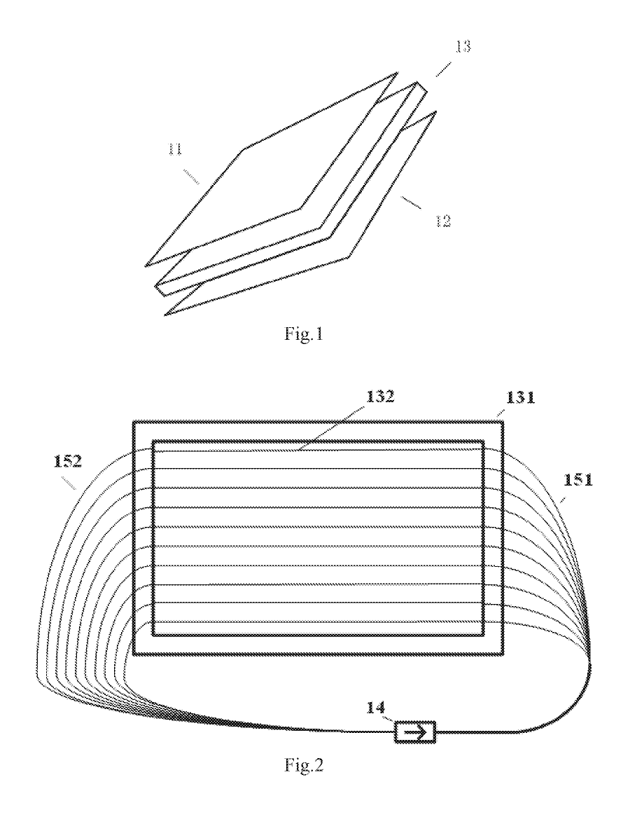

In an embodiment, as illustrated in FIGS. 1 and 2, the double side display device includes a first display panel 11, a second display panel L, and a backlight module 13. The backlight source 13 includes a case 131 and bare optical fibers 132 arranged in the case 131. The double side display device further includes the light source 14, the first external optical fibers 151 and the second external optical fibers 152. A leakage prevention layer (not shown in FIGS. 1 and 2) is arranged surrounding each of the first external optical fibers 151 and configured to prevent light from leaking. An output end of the light source 14 is connected to a first end of each of the bare optical fibers 132 via one of the external optical fibers 151. And the case 131 is arranged between the first display panel 11 and the second display panel 12.

A second end of each of the bare optical fibers 131 is connected to an input end of the light source 14 via one of the second external optical fibers 152. As a result, the unreleased visible light may return to the light source via the optical fiber to further reduce the power consumption.

In another embodiment, the double side display device further includes an electronically-controlled optical fiber coupler. There is a plurality of bare optical fibers, each of which corresponds to one or more rows of pixel units on the display panels. The light source is connected to an input end of the electronically-controlled optical fiber coupler via the external optical fibers, and output ends of the electronically-controlled optical fiber coupler are connected to the first ends of the bare optical fibers in a one-to-one correspondence manner via the external optical fibers. And second ends of the bare optical fibers are connected to an input end of the light source via the external optical fibers.

In this embodiment, there is the plurality of bare optical fibers, each of which corresponds to one or more rows of pixel units, so that the light emitted by the backlight source is in uniform.

In an optional embodiment, the double side display device further includes: a first timing controller, a second timing controller, a micro controller unit and a DC power conversion chip. The first tinting controller is configured to obtain a display data signal of each row of the pixel units on the first display panel from each data line in turn, and parse the obtained display data signal. The second timing controller is configured to obtain a display data signal of each row of the pixel units on the second display panel from each data line in turn, and parse the obtained display data signal. The micro controller unit is configured to obtain intensity control signals based on parsing results from the first timing controller and the second timing controller and corresponding to the display data signals of each row of the pixel units on the first display panel and the second display panel. The DC power conversion chip is configured to obtain intensity adjusting voltages based on the intensity control signals. And the electronically-controlled optical fiber coupler is further configured to adjust intensities of light beams outputted by the output ends based on the intensity adjusting voltages.

In this embodiment, the intensity of the back light emitted by the backlight source may be adjusted in real time, so that a function of scanning the back light may be implemented in the double side display device.

Alternatively, the double side display device further includes a circuit board. The electronically-controlled optical fiber coupler, the first timing controller, the second timing controller, the micro controller unit and the DC power conversion chip are mounted on the circuit board. As a result, the density of integration in the double side display device may be improved.

In the actual implementation, when the size of the double side display device is small, the light source may be of low power consumption, small size and generate less heat, so that the light source may be integrated on the circuit board.

In contrast, when the size of the double side display device is large, the light source may be of high power consumption, large size and generate more heat, and thus an independent light source module is needed and a particular area for the independent light source module should be reserved in the double side display device.

Alternatively, the double side display device further includes: a plurality of transparent protection tubes, wherein each of the bare optical fibers is arranged within a corresponding transparent protection tube, which is configured to protect the bare optical fiber.

In particular, the light source may be a pump light source, and the leakage prevention layer may be a reflective film.

In the following, the double side display device will be further explained in accordance with a specific embodiment.

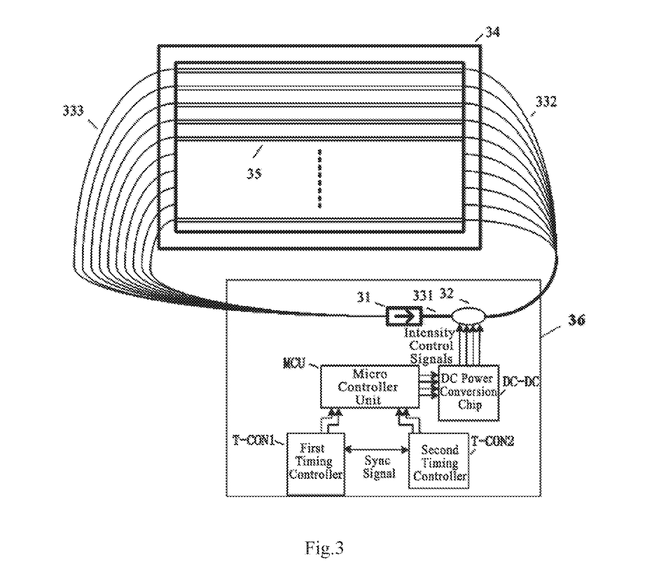

In this embodiment, as illustrated in FIG. 3, the double side display device includes a first display panel (not shown in FIG. 3), a second display panel (not shown in FIG. 3), a pump light source 31, an electronically-controlled optical fiber coupler 32, a first external optical fiber 331 on which a reflective film (not shown in FIG. 3) is coated, a plurality of second external optical fibers 332 on which reflective films are coated, a plurality of third external optical fibers 333 on which reflective films are coated, a case 34, a plurality of bare optical fibers each arranged in a transparent protection tube 35 (wherein the bare optical fibers are not shown in FIG. 3 because they are arranged in the transparent protection tubes), a circuit board 36, a first timing controller T-CON1, a second timing, controller T-CON2, a micro controller unit (MCU) and a DC power conversion chip (DC-DC). The case 34 is arranged between the first display panel and the second display panel (not shown in FIG. 3). The pump light source 31 is connected to an input end of the electronically-controlled optical fiber coupler 32 via the first external optical fibers 331, and output ends of the electronically-controlled optical fiber coupler 32 are connected to the first ends of the bare optical fibers in a one-to-one correspondence manner via the second external optical fibers 332. Second ends of the bare optical fibers are connected to an input end of the pump light source 31 via the third external optical fibers 333. The first timing controller T-CON1 is configured to obtain a display data signal of each row of the pixel units on the first display panel from each data line in turn, and parse the obtained display data signal. The second timing controller T-CON2 is configured to obtain a display data signal of each row of the pixel units on the second display panel from each data line in turn, and parse the obtained display data signal. And the first timing controller T-CON1 and the second timing controller T-CON2 are controlled by a synchronization signal.

The MCU is connected to the first timing controller T-CON1 and the second timing controller T-CON2 by a serial peripheral interface (SPI), and configured to obtain intensity control signals based on parsing results from h first timing controller T-CON1 and the second timing controller T-CON2 and corresponding to the display data signals of each row of the pixel units on the first display panel and the second display panel.

The DC power conversion chip DC-DC is connected to output ends for the intensity control signals of the MCU, and configured to obtain intensity adjusting voltages based on the intensity control signals. The electronically-controlled optical fiber coupler 32 is further configured to adjust intensities of light beams outputted to the second external optical fibers 332 by the output ends based on the intensity adjusting voltages. And all of the pump light source 31, the electronically-controlled optical fiber coupler 32, the first timing controller T-CON1, the second timing controller T-CON2, the MCU and the DC power conversion chip DC-DC are integrated on the circuit board, so that the density of integration in the double side display device may be improved.

In the double side display device according to the embodiments of the present disclosure, the light emitted by the pump light source enters the case of the backlight source via the external optical fibers on which the reflective films are coated, so that the bare optical fibers in the transparent protection tubes emit the visible light as the light-emitting element, and the unreleased light returns to the pump light source via the external optical fibers for being reused. The timing controllers of the two display panels parse the image data from respective channels, and transmit parsing results to the MCU. The MCU combines the parsing results from these two timing controllers, and generates control signals for changing the multi-path output voltages of the DC power conversion chip DC-DC, so as to adjust intensities of the lights in the optical fibers of the electronically-controlled optical fiber coupler. As a result, the light intensities in respective channels are changed and the function of scanning the back light is implemented.

According to the embodiments of the present disclosure, the thickness of the double side display device is significantly reduced, and the double side display device has good performance in both energy efficiency index (EEI) and practical utility.

In an embodiment, the present disclosure provides a method for driving the double side display device, including:

obtaining, by the first timing controller, a display data signal of each row of the pixel units on the first display panel from each data line in turn, and parsing the obtained display data signal;

obtaining, by the second timing controller, a display data signal of each row of the pixel units on the second display panel from each data line in turn, and parsing the obtained display data signal;

obtaining, by the micro controller unit, intensity control signals based on parsing results from the first timing controller and the second timing controller and corresponding to the display data signals of each row of the pixel units on the first display panel and the second display panel;

obtaining, by the DC power conversion chip, intensity adjusting voltages based on the intensity control signals; and

adjusting, by the electronically-controlled optical fiber coupler, intensities of light beams outputted to the first ends of the bare optical fibers based on the intensity adjusting voltages.

In an embodiment, the present disclosure provides an electrical device including the above double side display device.

The optional embodiments of the present disclosure have been discussed. It is appreciated that many modifications and improvements may be made to the present disclosure without departing from the principle of the present disclosure for a person skilled in the art. These modifications and improvements should also be deemed to be fallen within the scope of the present disclosure.

1. A double side display device, comprising:
a first display panel;
a second display panel;
a backlight source which comprises a case and bare optical fibers arranged in the case;
a light source; and
external optical fibers,
wherein a leakage prevention layer is arranged surrounding each of the external optical fibers and configured to prevent light from leaking;
an output end of the light source is connected to a first end of each of the bare optical fibers via one of the external optical fibers; and
the case is arranged between the first display panel and the second display panel.

2. The device according to claim 1, wherein a second end of each of the bare optical fibers is connected to an input end of the light source via one of the external optical fibers.

3. The device according to claim 1, further comprising an electronically-controlled optical fiber coupler,
wherein there is a plurality of bare optical fibers, each of which corresponds to one or more rows of pixel units on the display panels;
the light source is connected to an input end of the electronically-controlled optical fiber coupler via the external optical fibers, and output ends of the electronically-controlled optical fiber coupler are connected to the first ends of the bare optical fibers in a one-to-one correspondence manner via the external optical fibers; and
second ends of the bare optical fibers are connected to an input end of the light source via the external optical fibers.

4. The device according to claim 3, further comprising: a first timing controller, a second timing controller, a micro controller unit and a direct current (DC) power conversion chip, wherein
the first timing controller is configured to obtain a display data signal of each row of the pixel units on the first display panel from each data line in turn, and parse the obtained display data signal;
the second timing controller is configured to obtain a display data signal of each row of the pixel units on the second display panel from each data line in turn, and parse the obtained display data signal;
the micro controller unit is configured to obtain intensity control signals based on parsing results from the first timing controller and the second timing controller and corresponding to the display data signals of each row of the pixel units on the first display panel and the second display panel;
the DC power conversion chip is configured to obtain intensity adjusting voltages based on the intensity control signals; and
the electronically-controlled optical fiber coupler is further configured to adjust intensities of light beams outputted by the output ends based on the intensity adjusting voltages.

5. The device according to claim 4, further comprising a circuit board, wherein
the electronically-controlled optical fiber coupler, the first timing controller, the second timing controller, the micro controller unit and the DC power conversion chip are mounted on the circuit board.

6. The device according to claim 5, wherein the light source is integrated on the circuit board.

7. The device according to claim 1, further comprising: a plurality of transparent protection tubes, wherein each of the bare optical fibers is arranged within a corresponding transparent protection tube.

8. The device according to claim 1, wherein the light source is a pump light source, and the leakage prevention layer is a reflective film.

9. A method for driving the double side display device according to claim 4, comprising:
obtaining, by the first timing controller, a display data signal of each row of the pixel units on the first display panel from each data line in turn, and parsing the obtained display data signal;
obtaining, by the second timing controller, a display data signal of each row of the pixel units on the second display panel from each data line in turn, and parsing the obtained display data signal;
obtaining, by the micro controller unit, intensity control signals based on parsing results from the first timing controller and the second timing controller and corresponding to the display data signals of each row of the pixel units on the first display panel and the second display panel;
obtaining, by the DC power conversion chip, intensity adjusting voltages based on the intensity control signals; and
adjusting, by the electronically-controlled optical fiber coupler, intensities of light beams outputted to the first ends of the bare optical fibers based on the intensity adjusting voltages.

10. An electronic device comprising the double side display device according to claim 1.

11. The device according to claim 2, further comprising: a plurality of transparent protection tubes, wherein each of the bare optical fibers is arranged within a corresponding transparent protection tube.

12. The device according to claim 2, wherein the light source is a pump light source, and the leakage prevention layer is a reflective film.

13. The device according to claim 3, further comprising: a plurality of transparent protection tubes, wherein each of the bare optical fibers is arranged within a corresponding transparent protection tube.

14. The device according to claim 3, wherein the light source is a pump light source, and the leakage prevention layer is a reflective film.

15. The device according to claim 4, further comprising: a plurality of transparent protection tubes, wherein each of the bare optical fibers is arranged within a corresponding transparent protection tube.

16. The device according to claim 4, wherein the light source is a pump light source, and the leakage prevention layer is a reflective film.

17. The device according to claim 5, further comprising: a plurality of transparent protection tubes, wherein each of the bare optical fibers is arranged within a corresponding transparent protection tube.

18. The device according to claim 5, wherein the light source is a pump light source, and the leakage prevention layer is a reflective film.

19. The device according to claim 6, further comprising: a plurality of transparent protection tubes, wherein each of the bare optical fibers is arranged within a corresponding transparent protection tube.

20. The device according to claim 6, wherein the light source is a pump light source, and the leakage prevention layer is a reflective film.
